(19) United States
(12) Patent Application Publication
(10) Pub. No.: US 2015/0065103 A1
(43) Pub. Date: Mar. 5, 2015

(54) Device and Method for Enhancing a Call

(71) Applicant: Orange, Paris (FR)

(72) Inventors: Ghislain Moncomble, Plestin les Greves (FR); Jean-Sebastien Meurisse, Louannec (FR)

(21) Appl. No.: 14/470,417

(22) Filed: Aug. 27, 2014

(30) Foreign Application Priority Data
Aug. 27, 2013 (FR) 13 58212

(51) Int. Cl. H04M 3/42

(52) U.S. Cl. CPC H04M 3/42042
USPC 455/415

(57) ABSTRACT

A method and a device are provided for enhancing a call set up between at least one transmitting terminal and one receiving terminal. The transmitting terminal determines at least one content element associated with a datum identifying a user of the receiving terminal and associated with a datum identifying a user of the transmitting terminal. The selected content is then retrieved on the transmitting terminal. Optionally, the selected content is sent to the receiving terminal to enhance the call.

### FIELD OF THE DISCLOSURE

The invention resides in the field of telecommunications networks. It relates to a device and a method for enhancing a call.

### BACKGROUND OF THE DISCLOSURE

It is currently possible to set up enhanced communications between user terminals according to different call modes, notably audio, video, text, whiteboard, etc., communications.

Document US20100159942A1 describes a method for automatically enhancing a phone call by searching for information relating to the location of the terminals. The method enables the display, on the screen of a terminal of a first user communicating with a second user, of information such as the name and a photo of the second user, an indication of the location of the second user, and information relating to this location, such as the weather or news information.

According to the prior art, the enhancement information supplied to the first user is impersonal information which does not reflect the status of the relationship or the call habits between the first user and the second user.

With the increasing number of new communication protocols such as the RCS (Rich Suite Communication) protocol for example, a user can share pictures, videos, multimedia content with a communication partner during a telephone or videophone call. To do this, the user must select the file-sharing application on his terminal during the call, browse through the memory of his terminal and choose a file to send to his communication partner. The user can thus share personal data with his communication partner to enhance the call. However, this enhancement requires the interaction of the user on his terminal during the call. During a call, this user interaction may prove inconvenient in terms of terminal operation. The user may make operating errors affecting the call, for example by inadvertently disconnecting the call. Moreover, during these interactions on the terminal, the user is no longer concentrating on the call in progress with his communication partner.

### SUMMARY

An exemplary embodiment of the present disclosure relates to a method for enhancing a call set up between at least one transmitting terminal and one receiving terminal. The method includes:
a step of determination by the transmitting terminal of at least one content element associated with a datum identifying a user of the receiving terminal and associated with a datum identifying a user of the transmitting terminal,
a step of retrieving the determined content element, on the transmitting terminal.

The enhancement method according to an embodiment of the invention also enables automatic enhancement of a call set up between a transmitting terminal and a receiving terminal using enhancement information common to a user of the receiving terminal and to a user of the transmitting terminal.

Such enhancement information may correspond to data exchanged during preceding calls (SMS, MMS, e-mail, shared files, instant messages, drawings, etc.). According to this example, the transmitting terminal searches in a memory space associated with the transmitting terminal for data exchanged with the user of the receiving terminal during preceding calls. The transmitting terminal selects, for example, the most recent data exchanges as call enhancement information.

The content elements retrieved on the transmitting terminal as enhancement information are all the more relevant to the user of the transmitting terminal since these content elements correspond to common data, shared or exchanged between the user of the transmitting terminal and the user of the receiving terminal during preceding calls.

The call on the transmitting terminal side is automatically enhanced by means of the method according to an embodiment of the invention.

According to this method, the enhancement method steps can be carried out during a set up call in order to enhance a call in progress. Alternatively, the enhancement method can also be carried out before the call is set up, for example when the user of the transmitting terminal dials the number of the receiving terminal in order to set up a call.

The different embodiments or their characteristics mentioned below can be added independently or in combination with one another to the steps of the enhancement method defined above.

According to one particular embodiment of the invention, the enhancement method includes a step of sending to the receiving terminal at least one datum representing said determined content, in such a way that the receiving terminal retrieves said content during the set up call.

According to this particular embodiment of the invention, the call is also automatically enhanced on the receiving terminal side using enhancement information relevant to the call between the users of the transmitting terminal and the receiving terminal. In this particular embodiment of the invention, the call is enhanced on the transmitting terminal and on the receiving terminal with the same enhancement information.

Alternatively, enhancement information supplied by the transmitting terminal may correspond to online content shared by the user of the transmitting terminal with a group of users, including the user of the receiving terminal.

Thus, according to this particular embodiment of the invention, in order to share personal data, the user of the transmitting terminal does not need to operate his terminal to locate a content element to share with the user of the receiving terminal.

According to this particular embodiment of the invention, the datum representing said selected content can be transmitted during the call during the call set-up. In this latter variant, the selected content element is thus retrieved on the receiving terminal as soon as the call with the transmitting terminal is set up.

According to another particular embodiment of the invention, the datum representing the content element sent to the receiving terminal is a parameter enabling the receiving terminal to identify and access said content element stored in a memory space associated with the receiving terminal or in a memory space of a server of a communications network to which the receiving terminal is connected.

This particular embodiment of the invention enables the enhancement of the call in progress without requiring substantial resources for the transmission of the enhancement information. For example, if the transmitting terminal has selected a group of pictures stored on an online sharing site as enhancement information, the enhancement information is transmitted in the form of a link to access the group of pictures, for example a URL, possibly accompanied by access data such as a password. According to another example, when the method automatically selects data exchanged during preceding calls as enhancement information, the enhancement information is transmitted in the form of a parameter indicating the data type (SMS, MMS, e-mail, etc.) and time stamp data enabling the receiving terminal to identify the corresponding call data.

This particular embodiment of the invention optimizes the transmission bandwidth by not directly transmitting the content but by transmitting only a datum enabling the receiving terminal to locate the content in a memory which the receiving terminal can access.

This particular embodiment of the invention is also advantageous when the enhancement content is stored in both a memory associated with the transmitting terminal and a memory associated with the receiving terminal. In this particular embodiment of the invention, the content does not need to be retransmitted between the two terminals during the call.

According to another particular embodiment of the invention, during the step of determining at least one content element, a content element is selected for retrieval during the retrieval stage if its date of reception by the transmitting terminal or its date of transmission by the transmitting terminal falls after a predetermined date.

In this particular embodiment of the invention, the enhancement method also enables the selection of content elements which the transmitting terminal and the receiving terminal have recently exchanged.

The predetermined date may be defined according to the analysis of the history of the exchanges between the two communication partners. For example, the predetermined date is a date close to the current date if the exchanges are carried out at a high frequency (for example every day), or the predetermined date is a date further away from the current date if the exchanges are carried out at a low frequency (for example once a month). The predetermined date may thus vary according to the frequency of the exchanges between the communication partners.

When a plurality of relevant content elements have been selected, this embodiment also limits their number by filtering the content elements that precede the predetermined date.

According to another particular embodiment of the invention, during the step of determining at least one content element, a content element is selected for retrieval during the retrieval step if an update of said content element or of a set of content elements to which said content element belongs has been carried out since a preceding call set up between the transmitting terminal and the receiving terminal.

According to this particular embodiment of the invention, the transmitting terminal selects the content elements relating to the user of the receiving terminal and to the user of the transmitting terminal that have recently been updated. Thus, the call enhancement information is all the more relevant to the call since it corresponds to new or updated content of the user of the transmitting terminal and shared with the user of the receiving terminal.

According to another particular embodiment of the invention, prior to the determination step, the method includes a step of reception by the transmitting terminal of a datum representing a content element, the datum being sent by the receiving terminal. According to this particular embodiment of the invention, the determination step includes a step of searching, in a memory space associated with the transmitting terminal or in a memory space of a server of a communications network to which the transmitting terminal is connected, for said content element on the basis of the received datum.

According to this particular embodiment of the invention, the content element associated with a datum identifying the user of the receiving terminal and associated with a datum identifying a user of the transmitting terminal is determined on the basis of a datum representing this content element sent by the receiving terminal. The representing datum enables the transmitting terminal to identify and access said content element.

This particular embodiment of the invention is advantageous, for example, when the user of the receiving terminal has selected a content element to enhance the call or when the method for enhancing a call according to any one of the previously described embodiments is carried out by the receiving terminal.

This particular embodiment of the invention optimizes the transmission bandwidth by not directly transmitting the content element but by transmitting only a datum enabling the transmitting terminal to locate the content element in a memory which the transmitting terminal can access.

This particular embodiment of the invention is also advantageous when the enhancement content is stored in both a memory associated with the transmitting terminal and a memory associated with the receiving terminal. In this particular embodiment of the invention, the content does not need to be retransmitted between the two terminals during the call.

According to another particular embodiment of the invention, the datum identifying the user of the receiving terminal corresponds to a datum associated with a contact recorded in an address book associated with the transmitting terminal.

The identification datum corresponds, for example, to the telephone number of the receiving terminal, an e-mail address of the user of the receiving terminal, an SIP URI contact address (Session Initiation Protocol Uniform Resource Identifier in English) relating to the user of the receiving terminal.

Thus, in this particular embodiment of the invention, the identification datum determining at least one content element to enhance the call in progress is not necessarily the contact information relating to the receiving terminal and having served to set up the call in progress.

According to this particular embodiment of the invention, enhancement information or a type of enhancement information is associated with the contacts of an address book of the user of the transmitting terminal.

The transmitting user can thus associate content to be shared or types of content with each contact in his address book. This particular embodiment of the invention simplifies the search for content to enhance the call and enables the selection of relevant content for sharing with the user of the receiving terminal.

According to another particular embodiment of the invention, the determination step is carried out by a step of searching for a content element in a memory space associated with the transmitting terminal storing data of preceding calls between the user of the transmitting terminal and the user of the receiving terminal.

According to this particular embodiment of the invention, a content element is searched for in a call history, for example a call log or inbox or outbox dedicated to a message type (e-mail, SMS, MMS, instant messages, etc.). This particular embodiment of the invention simplifies the determination of relevant content for enhancing the call. Moreover, the search step is faster since it is carried out in a targeted memory space.

An embodiment of the invention also relates to a device for enhancing a call set up between at least one transmitting terminal and one receiving terminal. The device includes:
means for determining at least one content element associated with a datum identifying a user of the receiving terminal and associated with a datum identifying a user of the transmitting terminal,
means for retrieving the determined content element on the transmitting terminal.

The different embodiments or their characteristics mentioned below can be added independently or in combination with one another to the characteristics of the enhancement device defined above.

According to one particular embodiment of the invention, the enhancement device includes means for sending at least one datum representing said determined content to the receiving terminal, in such a way that the receiving terminal retrieves said content during the set up call.

According to another particular embodiment of the invention, the enhancement device includes means for receiving a datum representing a content element sent by the receiving terminal, and means for searching, in a memory space associated with the transmitting terminal or in a memory space of a server of a communications network to which the transmitting terminal is connected, for said content element on the basis of the received datum.

An embodiment of the invention also relates to a terminal including an enhancement device according to any one of the particular embodiments mentioned above.

An embodiment of the invention also relates to a message for enhancing a call set up between at least one transmitting terminal and one receiving terminal. The message includes at least one datum representing a content element, said content element being associated with a datum identifying a user of the receiving terminal and a datum identifying a user of the transmitting terminal, said datum representing a content element being sent in the form of a parameter enabling the receiving terminal to identify and access said content element stored in a memory space associated with the transmitting terminal or in a memory space of a server of a communications network to which the transmitting terminal is connected.

In one particular embodiment, the different steps of the method for enhancing a call are carried out by computer program instructions.

Consequently, an embodiment of the invention also relates to computer programs on an information medium, these programs being capable of being respectively implemented on a terminal or more generally on a computer, these programs respectively comprising instructions suitable for carrying out the different steps of the call enhancement method that has just been described.

These programs can use any programming language and may be in the form of source code, object code or intermediate code between source code and object code, such as in a partially compiled form, or in any other required form.

An embodiment of the invention also relates to a computer-readable information medium comprising instructions of a computer program as mentioned above.

The information medium may be any given entity or device capable of storing the program. For example, the medium may comprise a storage means, such as a ROM, for example a CD-ROM or a microelectronic circuit ROM, or a magnetic recording means, for example a USB stick or hard disk.

Moreover, the information medium may be a transmissible medium such as an electrical or optical signal which can be routed via an electrical or optical cable, by radio or by other means. The program according to an embodiment of the invention may, in particular, be downloaded from an Internet network.

Alternatively, the information medium may be an integrated circuit into which the program is incorporated, the circuit being suitable for carrying out or for being used in the carrying out of the call enhancement method in question.

The advantages of the enhancement device, the terminal, the enhancement message and the computer program are identical to those presented in relation to the enhancement method according to any one of the particular embodiments mentioned above.

### LIST OF FIGURES

Other advantages and characteristics will become evident from a reading of the following description of one particular embodiment of the invention, provided as a simple illustrative and non-limiting example, and the attached drawings, in which:

FIG. 1 shows an environment for implementing the invention according to one particular embodiment,

FIG. 2 shows steps of the method for enhancing a call according to one particular embodiment of the invention,

FIGS. 3A and 3B show schematically a datum representing enhancement information according to one particular embodiment of the invention,

FIG. 4 shows steps of the enhancement method according to another particular embodiment of the invention,

FIG. 5 shows a device carrying out the method for enhancing a call according to one particular embodiment of the invention.

### DESCRIPTION OF ONE PARTICULAR EMBODIMENT OF THE INVENTION

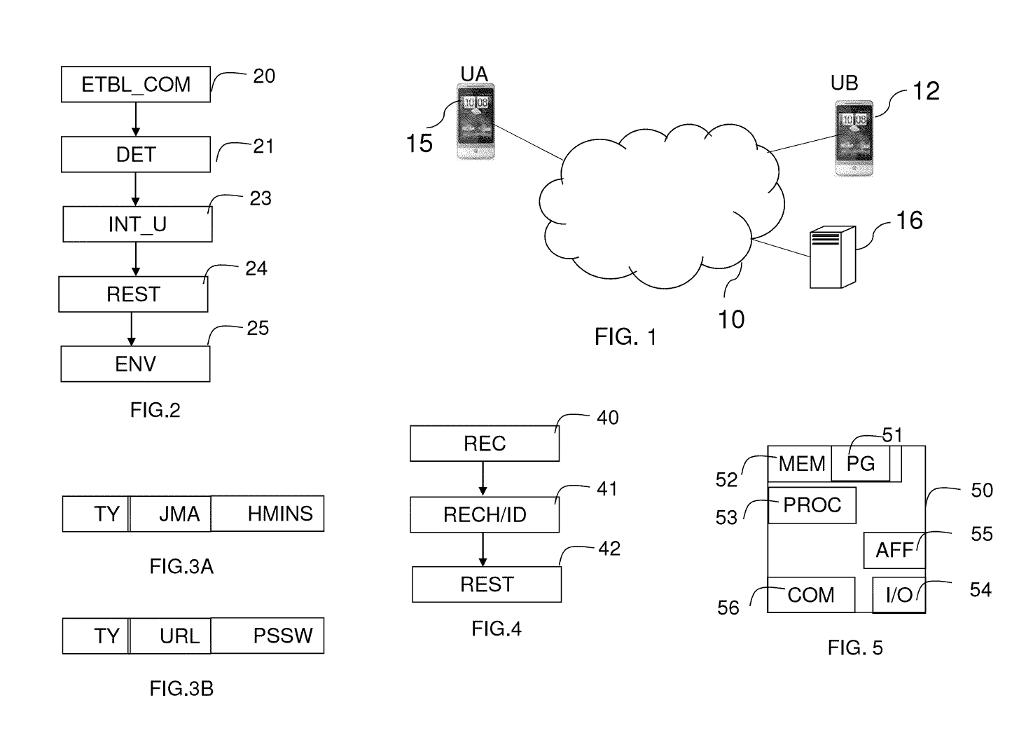

FIG. 1 shows an environment for implementing the invention according to one particular embodiment. The environment includes a communications network 10 to which terminals 12 and 15 and a data storage server 16 are connected.

The communications network 10 is, for example, a GSM, EDGE, 3G, 3G+ or 4G communications network implemented by an RCS architecture.

The terminals 12 and 15 can be any type of terminals enabling a telephone or videophone call to be set up, such as a portable telephone, a smartphone (intelligent phone in English), a tablet, a television connected to a telecommunications network, a personal computer on which a telephony application, also referred to as a softphone, is installed.

The terminals 12 and 15 are connected to the communications network 10 and can transmit and receive any type of calls via the communications network 10. Notably, the terminals 12 and 15 can set up calls enhanced by enhancement information received, for example, according to the RCS communication protocol.

The terminals 12 and 15 belong to a user UB and UA respectively. The users UB and UA have identification data relating to the communications network 10 which enable other users to set up calls to the users UA and UB. Identification data of this type correspond, for example, to an IMPU (IP Multimedia Public Identity in English), a telephone number, a URI contact address, an e-mail address, etc.

The data storage server 16 is an online content storage server enabling, for example, a user UA to store personal content in the network. The user UA can then access personal content stored on the data storage server 16 via a URL (Uniform Resource Locator) and, where appropriate, authentication data. The data storage server 16 corresponds, for example, to a server of an operator supplying an online content-sharing or social networking application.

The method for enhancing a call can be carried out according to one particular embodiment of the invention by the terminal 12 and/or the terminal 15 during a call set up between the terminal 12 and the terminal 15 in order to enhance the call in progress.

FIG. 2 shows steps of the method for enhancing a call according to one particular embodiment of the invention. The enhancement method is, for example, carried out by the terminal 15.

During a step 20, a call is set up between the terminal 15 and the terminal 12, in a known manner, for example according to the SIP protocol (Session Initiation Protocol in English). The set up call may be a telephone or videophone call or any other type of call (instant messaging, conference, whiteboard, etc).

During a step 21, the terminal 15 determines at least one content element associated with a datum identifying the user UB of the terminal 12 and associated with a datum identifying the user UA of the terminal 15.

A datum identifying the user UB corresponds, for example, to the telephone number for contacting the user UB on his terminal 12.

Alternatively, the datum identifying the user UB is a datum of the user UB supplied by the terminal 12 as a parameter of an SIP session initiation message, such as an SIP URI contact address, for example.

Alternatively, the datum identifying the user UB is a datum stored in an address book of the user UA and associated with the terminal 15. In this alternative, the datum is associated with the contact UB in the address book of the user UA. The datum corresponds, for example to an e-mail address, an identifier of a social networking or data-sharing Internet site, or a telephone number of the user UB.

The datum identifying the user UA corresponds, for example, to a telephone number for contacting the user UA on his terminal 15, to an e-mail address of the user US, to an SIP URI contact address of the terminal 15, etc.

On the basis of the datum identifying the user UB, the terminal 15 searches in the memory of the terminal 15 for files containing the datum identifying the user UB. The terminal 15 examines notably the files containing data exchanges of preceding calls between the terminal 12 and the terminal 15 and the files attached to these communication exchanges. The terminal 15 thus examines any type of files: e-mails, SMS, MMS, office automation documents (word processing documents, spreadsheets, etc.), pictures, videos.

For example, in the case where the terminal 15 has identified the e-mails sent by the user UB to the user UA, the datum identifying the user UB is then presented in the “From” field of the e-mail and the datum identifying the user UA is then presented in the “To” field of the e-mail. According to another example, in the case where the terminal 15 has identified e-mails sent by the user UA to the user UB, the datum identifying the user UB is then presented in the “To” field of the e-mail and the datum identifying the user UA is then presented in the “From” field of the e-mail.

Alternatively, the datum identifying the user UB may also be presented in metadata associated with picture or video content stored in a memory associated with the terminal 15 or on a data storage server 16. The metadata may, for example, correspond to marking data identifying the user UB in the content or to data indicating that the content has been shared with the user UB.

A datum identifying the creator or owner of the content or the terminal used to generate the content, for example the terminal 15, is also associated with the content. This datum thus corresponds to a datum identifying the user UA.

During step 21, the terminal 15 selects at least one content element from the group of previously identified content elements. For example, the terminal 15 selects a content element according to its reception, transmission or creation date.

According to one particular embodiment of the invention, the terminal 15 has a history of the calls between the users UA and UB. The history of the calls between the users UA and UB contains notably time stamp data of these calls and the type of call (e-mails, telephone or videophone calls, SMS, MMS, whiteboard, notifications, etc.). The call history corresponds, for example, to a transmitted or received call log, a message inbox or outbox for e-mails, SMS, MMS, instant messages, etc.

The calls listed in the call history are not limited to those transmitted or received from the terminal 15 of the user UA. The calls may have been transmitted or received from a different terminal of the user UA and the data relating to these calls may have been saved in the history.

The history of the calls between the users UA and UB may be stored locally on the terminal 15 or on a server (not shown) in the communications network 10.

According to one particular embodiment of the invention, for a content element relating to communication exchanges between the users UA and UB, the terminal 15 selects a content element if its transmission or reception date precedes a predetermined date. For example, the terminal 15 selects a content element if its transmission or reception date falls within the seven days preceding the date of the call in progress.

According to another particular embodiment of the invention, the terminal 15 selects a content element if an update of said content element or of a set to which said content element belongs has been carried out since a preceding call set up between the terminal 12 and the terminal 15. For example, when the group of content elements determined in step 21 includes content elements stored on the data storage server 16 shown in FIG. 1 and shared with the user UB, the terminal 15 selects the content elements that have been shared or updated recently.

During step 21, the terminal 15 thus determines at least one content element associated with a datum identifying the user UB and associated with a datum identifying the user UA.

According to one particular embodiment of the invention, during a step 23, the terminal 15 presents a list of the content elements determined during step 21 to the user UA during the call. The list contains notably information representing the content, such as the content type, the transmission, reception or content modification date, the subject of the content.

According to one particular embodiment of the invention, the selected content elements are presented in chronological order according to their date stamp datum, for example from the most recent to the oldest.

During step 23, the user UA validates the content elements in the list that the user UA wishes to transmit to the user UB, via a user interaction on the terminal 15.

Step 23 is optional, wherein the terminal 15 can automatically determine the content intended to enhance the call set up between the terminal 15 and the terminal 12 by selecting, for example, the most recent content element from the list of content elements determined during step 21.

During a step 24, the terminal 15 retrieves on a screen a content element determined during step 21, for example the first content element in the list or the first content element validated by the user UA during step 23.

According to one particular embodiment of the invention, during a step 25, the terminal 15 sends to the terminal 12 at least one datum representing the content element selected in step 21 or validated by the user UA in step 23. The datum representing the content element is sent during the call, for example according to the RCS protocol. The terminal 12 can thus retrieve on its terminal the content element sent by the terminal 15. This particular embodiment of the invention thus enables symmetrical enhancement of the call using the same content element for the two users UA and UB.

The invention is not limited to the case of two communicating terminals. The method for enhancing a call as described in relation to FIG. 2 extends to cases of communication between more than two terminals.

According to one particular embodiment of the invention, the datum representing the content is sent to the terminal 12 in the form of a parameter enabling the terminal 12 to identify the content and access the identified content.

In this particular embodiment of the invention, the parameter is sent, for example, in an SIP call message including an owner field as shown in FIGS. 3A and 3B.

According to a first example, the content element sent by the terminal 15 to the terminal 12 is a content element relating to a call previously set up between the terminal 15 and the terminal 12.

According to this first example, the parameter enabling identification of the content is sent in the form of time stamp data as shown in FIG. 3A. In FIG. 3A, the parameter includes a field TY indicating the type of content to be identified, for example an e-mail sent by the user UA, a field JMA indicating the content transmission time stamp data and a field HMINS indicating an identifier of the content, for example an identifier of the e-mail.

According to a second example, the content element sent by the terminal 15 to the terminal 12 is a content element stored on the data storage server 16 and accessible via a URL, for example a picture. According to this example, the parameter enabling identification of the content is sent in the form shown in FIG. 3B. In FIG. 3B, the parameter includes a field TY indicating the type of content to be identified, for example a picture stored in the network, a URL field indicating the electronic address at which the content is accessible and pointing to a memory space of the data storage server 16, and possibly a field PSSW containing authentication data enabling the terminal 12 to authenticate itself and access the stored content.

In the embodiments described in relation to FIGS. 3A and 3B, the Field TY also enables identification of an application for accessing the content and for indicating the memory location in which the content is stored. For example, for an SMS content element, the content element is stored in a memory space of the terminal 15 dedicated to the storage of the SMS inbox or outbox.

FIG. 4 shows steps of the enhancement method according to one particular embodiment of the invention. The enhancement method is, for example, carried out by the terminal 12 during a call set up with the terminal 15.

During a step 40, the terminal 12 receives a datum representing a content element sent by the terminal 15. For example, when the terminal 15 carries out the enhancement method described in relation to FIG. 2, the datum representing the content element corresponds to the datum sent by the terminal 15 during step 25 in FIG. 2. According to another example, the representing datum received by the terminal 12 corresponds to a datum representing a content element selected by the user UA of the terminal 15 during the call.

According to any one of the previously described examples, the datum is, for example, sent in the form of a message including notably the fields described in relation to FIG. 3A or FIG. 3B.

During a step 41, the terminal 12 extracts from the message received in step 40 the parameters enabling identification of a content element in a memory space associated with the terminal 12 or in a memory space of the data storage server 16 in FIG. 1.

According to a first example, the datum representing the content is sent in the form described in relation to FIG. 3A. During step 41, the terminal 12 searches for a content element of the type indicated by the field TY and including the date stamp data indicated in the field JMA and the identifier HMINS. According to the content type indicated by the Field TY, for example an e-mail sent by the terminal 15 of the user UA, the terminal 12 identifies a memory space in which to search for the content including the timestamp data JMA. If the terminal 12 identifies a plurality of content elements of the same type including the same time stamp data, the terminal 12 identifies the content element as the one containing the identifier HMINS.

According to a second example, the datum representing the content is sent in the form described in relation to FIG. 3B. During step 41, the terminal 12 accesses the content via the electronic address URL pointing to a memory space of the data storage server 16 in FIG. 1. If authentication data are present, the terminal 12 authenticates itself using the authentication data PSSW on the data storage server 16. The terminal 12 then loads the content into a memory.

During the content element search and identification step 41, the terminal 12 determines, on the basis of the datum received in step 40, a content element associated with a datum identifying the user UB and associated with a datum identifying the user UA.

During a step 42, the terminal 12 retrieves the content element identified or loaded into the memory on the screen of the terminal 12. The content is retrieved, for example, by the call application used for the call in progress if the call application is suitable for retrieving the identified content. The content element can also be retrieved by an application dedicated to the content element, for example the application which served to exchange the content element during a preceding call.

The user UB can thus access the content during the call with the user UA.

FIG. 5 shows a device for carrying out the method for enhancing a call according to one particular embodiment of the invention.

The device 50 includes a storage module 52, for example a memory (MEM), a processing unit 53, equipped, for example, with a microprocessor (PROC), and controlled by the computer program (PG) 51 carrying out the method for enhancing a call as described in relation to FIG. 2 or FIG. 3. On initialization, the code instructions of the computer program 51 are, for example, loaded into the memory (MEM) before being executed by the processor (PROC) of the processing unit 53. The processor of the processing unit 53 carries out the steps of the method for enhancing a call set up between at least one transmitting terminal and one receiving terminal, and notably a step of determination by the transmitting terminal of at least one content element associated with a datum identifying a user of the receiving terminal and associated with a datum identifying a user of the transmitting terminal, and a step of retrieving the determined content element on the transmitting terminal, according to the instructions of the computer program 51.

The storage module 52 also enables the storage on the device 50 of the content element associated with a datum identifying the user of the receiving terminal and associated with a datum identifying the user of the transmitting terminal.

According to one particular embodiment of the invention, the storage module 52 contains the data associated with the contacts of an address book associated with the transmitting terminal or associated with the user of the transmitting terminal.

The device 50 also comprises call means 56. The call means are, for example, implemented by a call module (COM). The call module enables notably the device 50 to set up calls via the communications network 10 in FIG. 1.

According to one particular embodiment of the invention, the call module (COM) enables the transmission to the receiving terminal of a datum representing a content element determined by the data processing unit (53).

According to one particular embodiment of the invention, the call module (COM) enables the device 50 to receive a datum representing a content element for enhancing a call in progress with a receiving terminal.

According to one particular embodiment of the invention, the device 50 also includes user interaction means 54 (I/O) enabling the user to interact with the device 50, for example to validate a determined content element. The user interaction means 54 are, for example, implemented by means of a user interface. This user interface may correspond to a keyboard, a mouse, or a touch screen.

The device 50 includes retrieval means 55 notably for retrieving the call enhancement information, for example a content element identified during the determination step. The retrieval means are, for example, implemented by a display module (AFF), such as a screen.

The device 50 is included in a terminal, such as, for example, the terminal 15 or the terminal 12 in FIG. 1. More generally, the device 50 is included in a terminal, such as, for example, a fixed or mobile personal computer, a mobile telephone, a tablet, a connected television, a smartphone, etc.

Although the present disclosure has been described with reference to one or more examples, workers skilled in the art will recognize that changes may be made in form and detail without departing from the scope of the disclosure and/or the appended claims.

What is claimed is:

1. A method for enhancing a call set up between at least one transmitting terminal and one receiving terminal, the method comprising:
determining by the transmitting terminal at least one content element associated with a datum identifying a user of the receiving terminal and associated with a datum identifying a user of the transmitting terminal, and
retrieving the determined content element on the transmitting terminal.

2. The method for enhancing a call according to claim 1, wherein the method includes transmitting to the receiving terminal at least one datum representing said determined content, in such a way that the receiving terminal retrieves said content during the set up call.

3. The method for enhancing a call according to claim 2, wherein the datum representing the content sent to the receiving terminal is a parameter enabling the receiving terminal to identify and access said content element stored in a memory space associated with the receiving terminal or in a memory space of a server of a communications network to which the receiving terminal is connected.

4. The method for enhancing a call according to claim 1, wherein, during the step of determining at least one content element, a content element is selected for retrieval during the retrieval step if its date of reception by the transmitting terminal or transmission by the transmitting terminal falls after a predetermined date.

5. The method for enhancing a call according to claim 1, wherein, during the step of determining at least one content element, a content element is selected for retrieval during the retrieval step if an update of said content element or a set of content elements to which said content element belongs has been carried out since a preceding call set up between the transmitting terminal and the receiving terminal.

6. The method for enhancing a call according to claim 1, wherein, prior to the determining step, the method includes a step of reception by the transmitting terminal of a datum representing a content element sent by the receiving terminal, and determining step includes a step of searching, in a memory space associated with the transmitting terminal or in a memory space of a server of a communications network to which the transmitting terminal is connected, for said content element on the basis of the received datum.

7. The method for enhancing a call according to claim 1, wherein the datum identifying the user of the receiving terminal corresponds to a datum associated with a contact recorded in an address book associated with the transmitting terminal.

8. The method for enhancing a call according to claim 1, wherein the determining step is carried out by a step of searching for a content element in a memory space associated with the transmitting terminal storing data of preceding calls between the user of the transmitting terminal and the user of the receiving terminal.

9. A device for enhancing a call set up between at least one transmitting terminal and one receiving terminal, the device comprising:
means for determining at least one content element associated with a datum identifying a user of the receiving terminal and associated with a datum identifying a user of the transmitting terminal, and
means for retrieving the determined content element on the transmitting terminal.

10. The device for enhancing a call according to claim 9, wherein the device includes means for transmission to the receiving terminal of at least one datum representing said determined content, in such a way that the receiving terminal retrieves said content during the set up call.

11. The device for enhancing a call according to claim 9, wherein the device includes:
means for receiving a datum representing a content element sent by the receiving terminal, and
means for searching, in a memory space associated with the transmitting terminal or in a memory space of a server of a communications network to which the transmitting terminal is connected, for said content element on the basis of the received datum.

12. A terminal including a device according to claim 9.

13. A method comprising:
generating a message for enhancing a call set up between at least one transmitting terminal and one receiving terminal, the message including at least one datum representing a content element, said content element being associated with a datum identifying a user of the receiving terminal and with a datum identifying a user of the transmitting terminal, said datum representing a content element being sent in the form of a parameter enabling the receiving terminal to identify and access said content element stored in a memory space associated with the transmitting terminal or in a memory space of a server of a communications network to which the transmitting terminal is connected; and
transmitting the message from the transmitting terminal to the receiving terminal.

14. A non-transmissible computer-readable information medium comprising a computer program stored thereon and comprising program code instructions for carrying out steps of a method for enhancing a call between at least one transmitting terminal and one receiving terminal when the program is executed by a processor, wherein the method comprises:
determining by the transmitting terminal at least one content element associated with a datum identifying a user of the receiving terminal and associated with a datum identifying a user of the transmitting terminal, and
retrieving the determined content element on the transmitting terminal.
